(19) United States
(12) Patent Application Publication
(10) Pub. No.: US 2023/0061340 A1
(43) Pub. Date: Mar. 2, 2023

(54) CHAIN PULLERS

(71) Applicant: David Jones, Pleasant Grove, UT (US)

(72) Inventor: David Jones, Pleasant Grove, UT (US)

(21) Appl. No.: 17/823,207

(22) Filed: Aug. 30, 2022

Related U.S. Application Data
(60) Provisional application No. 63/238,947, filed on Aug. 31, 2021.

(51) Int. Cl. B21L 21/00

(52) U.S. Cl. CPC B21L 21/00

(57) ABSTRACT

Described herein are examples of chain pullers, which may include a first arm, a second arm, a first linkage, a second linkage, and an actuator. The first arm may include a linkage end and an engagement end. The second arm may include a linkage end and an engagement end. The first linkage may include a proximal end connected to the first arm and a distal end connected to the second arm. The second linkage may include a proximal end connected to the first arm and a distal end connected to the second arm. The actuator may have a first end connected to the first arm and a second end connected to the second arm. The first arm, the second arm, the first linkage, the second linkage, and the actuator may be configured such that when the actuator is actuated, a distance between the engagement ends is changed.

### CROSS-REFERENCE TO RELATED APPLICATION

The present application claims the benefit of U.S. Provisional Patent Application No. 63/238,947 entitled “CHAIN PULLERS”, filed on Aug. 31, 2021. The entire contents of the above-listed application are hereby incorporated by reference for all purposes.

### BACKGROUND

Conveyors operate generally on a principle of transforming rotational force into linear motion, and such linear motion may be configured as straight-line motion or over a variety of paths. Such conveyors may require maintenance to provide for normal operation. Such maintenance may address problems that arise, component upgrades or wear and tear on the conveyor through operation. Chain-based conveyors may provide for conveyance of a transported item or an operative item, for example, a roller in a car wash. Such rollers, like other conveyed items, may need to be removed and/or replaced from time to time.

### BRIEF DESCRIPTION OF THE DRAWINGS

The present description will be understood more fully when viewed in conjunction with the accompanying drawings of various examples of chain pullers. The description is not meant to limit the chain pullers to the specific examples. Rather, the specific examples depicted and described are provided for explanation and understanding of chain pullers. Throughout the description, the drawings may be referred to as drawings, figures, and/or FIGs.

FIG. 1 illustrates a system level of a chain puller, according to an embodiment.

FIG. 2 illustrates a linkage subsystem of a chain puller, according to an embodiment.

FIG. 3 illustrates a method of slacking a chain section using a chain puller, according to an embodiment.

FIG. 4 illustrates an example of engaging a chain puller to a chain of a conveyor, according to an embodiment.

FIG. 5 illustrates an example of actuating an actuation subsystem to slack a chain section, according to an embodiment.

FIG. 6 illustrates a method of restoring tension to a chain section using a chain puller, according to an embodiment.

FIG. 7 illustrates an example of actuating a chain puller actuator to restore normal tension to a chain section, according to an embodiment.

FIG. 8 illustrates an actuator electronic controller 800, according to an embodiment. The actuator electronic controller 800 includes internal and external data resources.

FIG. 9 illustrates a device schematic 900 for various devices used in the actuator electronic controller 800, according to an embodiment

FIG. 10 illustrates a system level of a chain puller in an open configuration, according to an alternate embodiment.

FIG. 11 illustrates a linkage disconnect of a chain puller, according to the alternate embodiment.

FIG. 12 illustrates a system level of a chain puller in a disconnected configuration, according to the alternate embodiment.

FIG. 13 illustrates a system level of a chain puller in a collapsed configuration, according to the alternate embodiment.

### DETAILED DESCRIPTION

Chain pullers as disclosed herein will become better understood through a review of the following detailed description in conjunction with the figures. The detailed description and figures provide merely examples of the various embodiments of chain pullers. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Conventional conveyor maintenance operations may include a variety of methods involving stopping a chain of the conveyor and partially or fully disassembling it. Such disassembly can involve removing a shear pin from a chain link connection in order to disconnect the chain links. In some conventional implementations, the entire chain must be de-tensioned in order to provide sufficient slack in the chain to unlink one or more of the chain link connections. Such need for maintenance may be regular when the chain is used to convey an item of interest and is subject to harsh environmental conditions (e.g., a car wash conveyor roller), and the item of interest needs to be removed for cleaning or replacement.

Often, conventional methods require accessing a portion of the chain at an inconvenient or normally inaccessible location, for example at an end or turning point of the chain, or underneath the chain. In an example where a conveyor is disposed within a floor (e.g., a car wash conveyor), the chain may be difficult to access at its ends and inaccessible from beneath. If an attempt is made to unlink it from the exposed top portion of the chain, ends of an unlinked chain may slide apart under the weight of the chain and present great difficulty in bringing the ends of the chain together again for re-linking.

Implementations of chain pullers may address some or all of the problems described above. A chain puller system may include a first arm, a second arm, a first linkage, a second linkage, and an actuator. The first arm may include a first linkage end and a first engagement end. The second arm may include a second linkage end and a second engagement end. The first linkage may include a first proximal end connected to the first arm and a first distal end connected to the second arm. The second linkage may include a second proximal end connected to the first arm and a second distal end connected to the second arm. The actuator may have a first end connected to the first arm and a second end connected to the second arm. The first arm, the second arm, the first linkage, the second linkage, and the actuator may be configured such that when the actuator is actuated, a distance between the first engagement end and the second engagement end may be changed.

Implementations herein may capitalize on the characteristic that long chains, though often used due to their efficiency of distributing force substantially uniformly through their entire length, can stretch under tension. When the engagement ends of the chain puller are engaged with a chain, by actuating the actuator and changing the distance between them, the section of chain within the engagement ends may be slacked (by stretching the chain outside of the engagement ends) such that a chain link connection between the engagement ends may be unlinked without the chain sliding apart under the weight of the chain. Further, ends of an unlinked chain within the section of chain between the engagement ends of the chain puller may be re-linked without needing to pull them together (i.e., use additional force to pull the chain together).

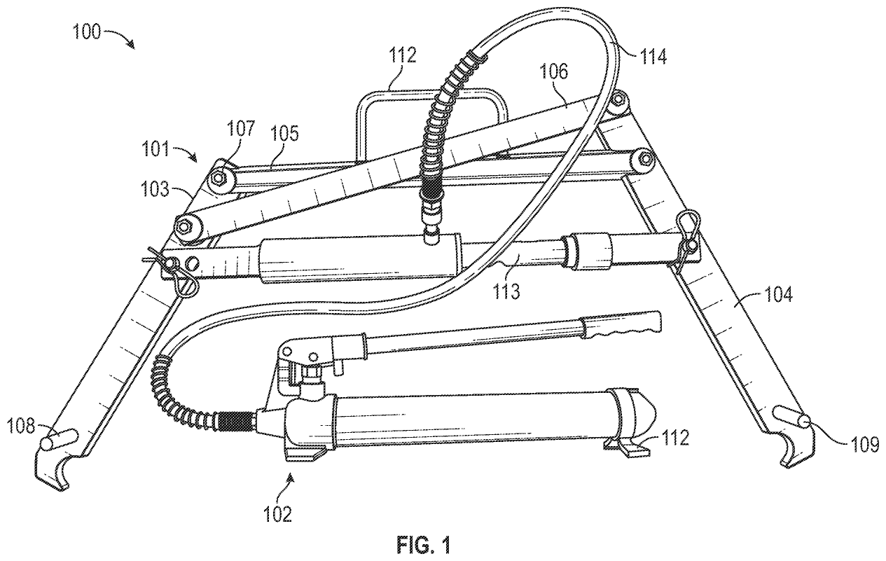

FIG. 1 illustrates a system 100 level of a chain puller, according to an embodiment. System 100 may include a linkage subsystem 101 and an actuation subsystem 102. System 100 may illustrate an embodiment of the chain puller, depicting the operative connections between the linkage subsystem 101 and the actuation subsystem 102. Use of the actuation subsystem 102 with the linkage subsystem 101 may enable the slacking of a section of a conveyor's chain.

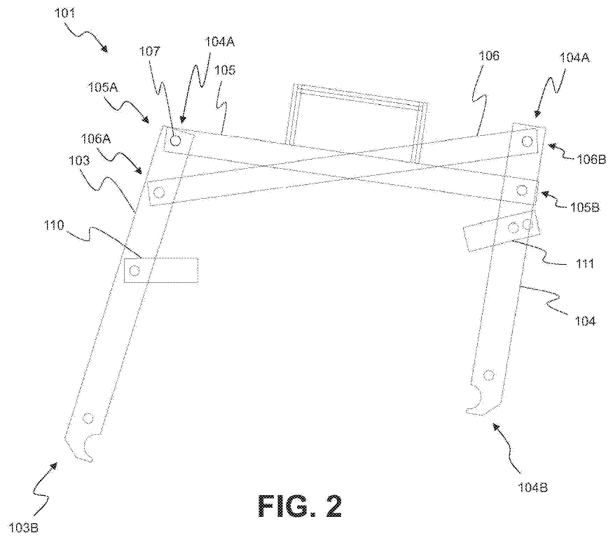

The linkage subsystem may include a first arm 103, a second arm 104, a first linkage 105, and a second linkage 106. Two or more of the arms 103 and 104 and linkages 105 and 106 may be connected using a fastener (e.g., a rivet, bolt, carriage bolt, pin, cotter pin, etc.), such as a fastener 107. A handle 112 for carrying and manipulating the system 100 may be disposed on one of the linkages, for example, the first linkage 105. Pins 108 and 109 may be disposed proximate engagement ends of the arms 103 and 104, respectively, which may provide for stability when the system 100 is engaged to a chain and prevent over-insertion of the engagement ends through the links of the chain. Further detail as to the arms, the linkages, and the arrangement thereof may be discussed in accompanying FIG. 2.

The actuation subsystem 102 may include an actuator 113, which may be connected via a connection line 114 to an external driver 112. In some embodiments, the actuator 113 may be a hydraulic actuator (e.g., a hydraulic piston actuator), the connection line 114 may be a hydraulic hose, and the external driver 112 may be a hydraulic pump. In other embodiments, the actuator 113 may be a pneumatic actuator (e.g., a pneumatic piston actuator), the connection line 114 may be a pneumatic hose, and the external driver 112 may be a pneumatic pump. In other embodiments, the actuator 113 may be an electric actuator (e.g., a linear electric actuator), the connection line 114 may include one or more wires, and the external driver 112 may be an electronic controller (i.e., a machine interface, machine control unit, control panel, or switch).

The first arm 103, the second arm 104, the first linkage 105, the second linkage 106, and the actuator 113 may be configured such that when the actuator is actuated, a distance between the first engagement end and the second engagement end may be changed.

FIG. 2 illustrates the linkage subsystem 101 of a chain puller, according to an embodiment. FIG. 2 may provide additional detail as to the components of the linkage subsystem 101 and the relationships therebetween.

The first arm 103 may include a first linkage end 103A and a first engagement end 103B. The second arm 104 may include a second linkage end 104A and a second engagement end 104B.

The first engagement end 103B and the second engagement end 104B may be configured with hook cutouts configured to partially encircle shear pins of a chain, therefore reducing a susceptibility of the respective engagement end to slip off the chain when compressing the chain section to be slacked.

The first engagement end 103B and the second engagement end 104B may be configured with pins or protrusions (e.g., the pins 108 and 109), which may be larger than a width of a chain the system 100 is rated to be used for. The pins or protrusions may prevent the engagement ends from being inserted through the chain link further than recommended for a given embodiment and may provide for stability when the system 100 is engaged with the chain.

The first linkage 105 may include a first proximal end 105A connected to the first arm 103 and a first distal end 105B connected to the second arm 104. The second linkage 106 may include a second proximal end 106A connected to the first arm 103 and a second distal end 106B connected to the second arm 104. The first linkage 105 and the second linkage 106 may be arranged in a crossover (e.g. scissor) fashion, that is, the first proximal end 105A of the first linkage 105 connected to the first arm 103 may be closer to the first linkage end 103A than the second proximal end 106A of the second linkage 106 connected to the first arm 103, and the second proximal end 106B of the second linkage 106 connected to the second arm 104 may be closer to the second linkage end 104A than the first proximal end 105B of the first linkage 105 connected to the second arm 104.

The actuator 113 be connected using a first end connector 110 connected to the first arm 104 and a second end connector 111 connected to the second arm 105. The first end connector 110 may be connected to the first arm 103 between a connection point of the second linkage 106 and the first engagement end 103B. The second end connector 111 may be connected to the second arm 104 between a connection point of the first linkage 105 and the second engagement end 104B.

Various components of the arms, linkages, connectors and fasteners may be constructed of various materials, including, inter alia, a metal (e.g., stainless steel, carbon steel, iron, cast iron, aluminum, nickel, titanium, or another metal, or a metal alloy), a composite material (e.g., carbon fiber), or a plastic (e.g., ABS, polylactic acid (PLA), polycarbonate (PG), polyethylene terephthalate (PET, PETT, PETG, PETE), nylon, high-density polyethylene (HDPE), polyvinyl chloride (PVC), low-density polyethylene (LDPE), polypropylene (PP), or polystyrene, or other suitable plastics). Joints where multiple components are joined by a fastener connection or otherwise may be, for example, greased, oiled, or greaseless.

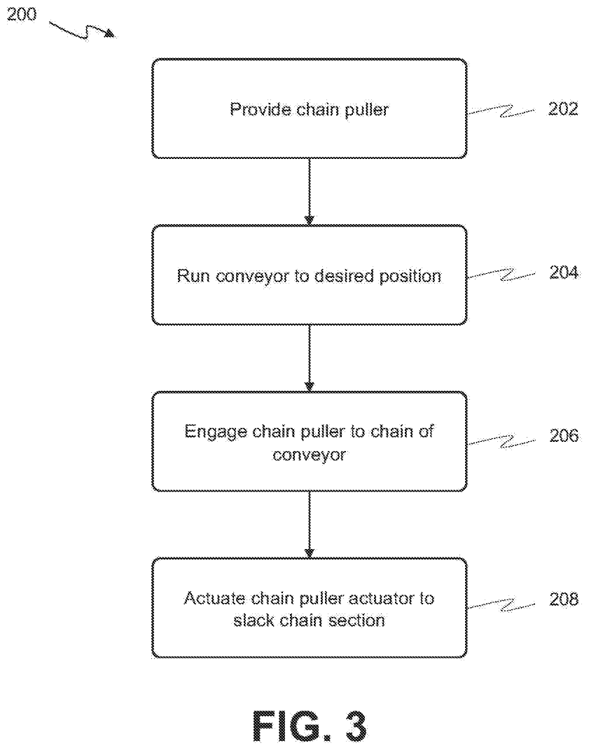

FIG. 3 illustrates a method 200 of slacking a chain section using a chain puller, according to an embodiment.

At 202, a chain puller may be provided. The chain puller may include a first arm, a second arm, a first linkage, a second linkage, and an actuator. The first arm may include a first linkage end and a first engagement end. The second arm may include a second linkage end and a second engagement end. The first linkage may include a first proximal end connected to the first arm and a first distal end connected to the second arm. The second linkage may include a second proximal end connected to the first arm and a second distal end connected to the second arm. The actuator may have a first end connected to the first arm and a second end connected to the second arm. The first arm, the second arm, the first linkage, the second linkage, and the actuator may be configured such that when the actuator is actuated, a distance between the first engagement end and the second engagement end is changed.

At 204, the conveyor may be run to a desired position. For example, the conveyor may be run until the section of the conveyor's chain which is sought to be disconnected is accessible with sufficient space to engage the chain puller to it.

At 206, the chain puller may be engaged to the chain of the conveyor. To do so, the engagement ends of the arms of the chain puller may be inserted through links of the chain. In some embodiments including pins disposed proximate to the engagement ends (e.g., the pins 108 and 109 of system 100), the engagement ends may be inserted up to the chain making contact with the pins. When inserted, the chain puller may be in an open position.

At 208, the chain puller's actuator may be actuated to slack the chain section. The chain section may be slacked by the actuator pulling the engagement ends of the arms toward each other, thus shrinking the distance between them. As the engagement ends of the arms are pulled together, the chain section within them may be slacked and the remainder of the chain may be tensioned (e.g., stretched to provide for slack within the chain section being slacked).

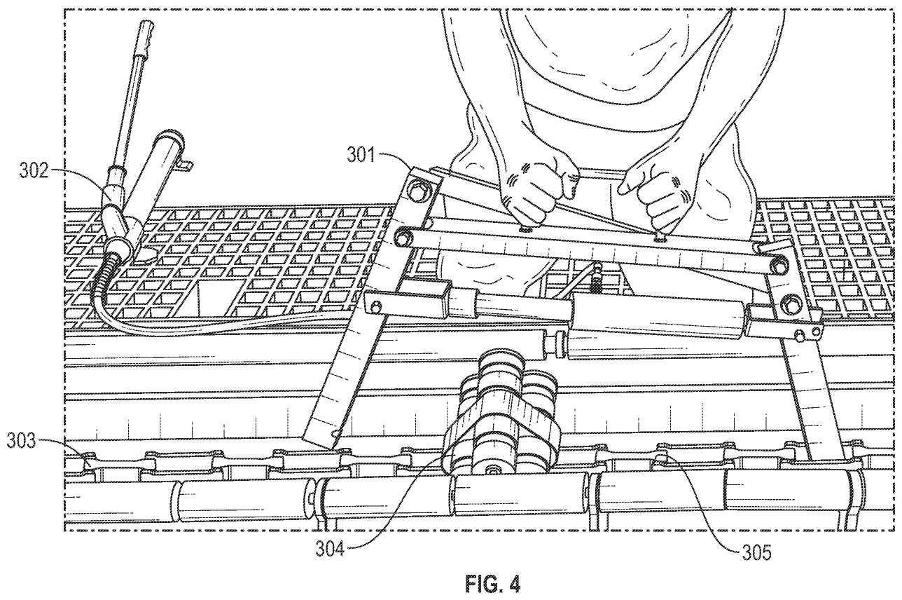

FIG. 4 illustrates an example of engaging a chain puller to a chain of a conveyor, according to an embodiment. Engaging the chain puller to the chain of the conveyor may provide for an ability to use the chain puller to slack a section of the chain for maintenance or disassembly purposes.

The chain puller may have a linkage subsystem 301 similar to the linkage subsystem 101 and an actuation subsystem 302 similar to the actuation subsystem 102. By engaging engagement ends of the linkage subsystem 301, which may be similar to the engagement ends 103B and 104B, to a chain 303 of the conveyor, a chain section 305 of the chain 303 may be spanned by the linkage subsystem 301. The chain section 305 may include an item of interest 304, for example needing maintenance or replacement.

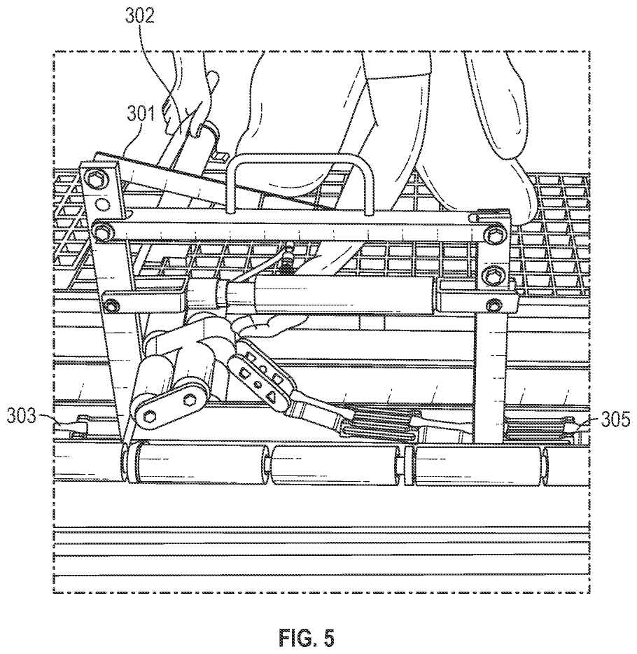

FIG. 5 illustrates an example of actuating the actuation subsystem 302 to slack the chain section 305, according to an embodiment. The slack in the chain section 305 of the chain 303 affected by actuating the chain puller actuator may enable a chain link connection to be unliked without the unlinked ends sliding away from the point of unlinking due to the weight of the chain. As can be seen in FIG. 5, the distance between the engagement ends of the linkage subsystem 301 has been reduced, resulting in the chain 303 being slacked through the chain section 305 having an item of interest 304.

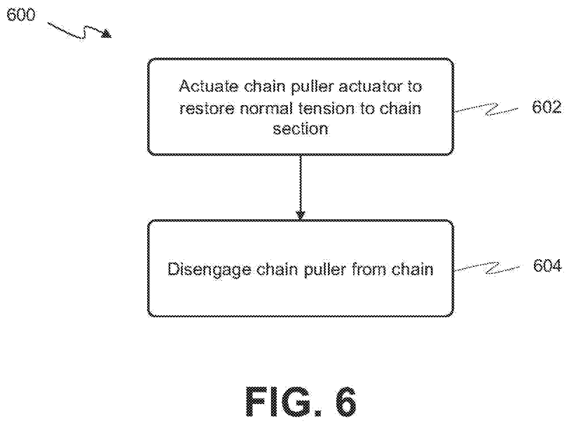

FIG. 6 illustrates a method 600 of restoring tension to a chain section using a chain puller, according to an embodiment. Method 600 may be used to restore the chain to its normal operative state. A normal tension in the chain, which may be restored using the method 600, may be a tension such that the tension of the portions of the chain within the chain section that was slacked is substantially equalized with the portions of the chain outside of the chain section that was slacked.

At 602, a chain puller actuator may be actuated to restore a normal tension to a chain section. The actuator may affect this restoration of normal tension by being released or actuated such that the linkage subsystem is again in an open position, (i.e., the distance between the engagement ends of the linkage subsystem is returned to its greater value compared to its value when the chain is slacked). In some embodiments employing a hydraulic actuator, this may be affected by venting the hydraulic actuator to allow it to return to its unactuated state.

At 604, the chain puller may be disengaged from the chain. With the engagement ends of the linkage subsystem in their open position, disengaging the chain puller from the chain may involve lifting the chain puller off the chain such that the engagement ends of the linkage subsystem are no longer inserted through links of the chain.

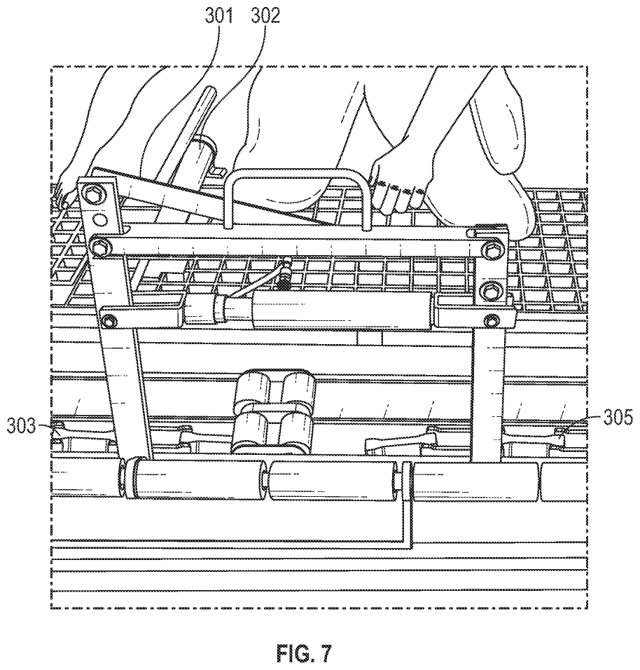

FIG. 7 illustrates an example of actuating a chain puller actuator to restore normal tension to a chain section 305, according to an embodiment. Upon restoration of normal tension, the chain puller may be disengaged (i.e., removed) from the chain 303, and the chain 303 may be, for example, used in its normal application.

As the actuation subsystem 302 is actuated to open (e.g., increase the distance between) the engagement ends of the linkage subsystem 301, the chain section 305 of the chain 303 may be returned to a normal tension.

FIG. 8 illustrates an actuator electronic controller 800, according to an embodiment. The actuator electronic controller 800 includes internal and external data resources. The actuator electronic controller 800 may result in reduced memory allocation at client devices and may conserve memory resources for application servers.

The actuator electronic controller 800 may include a cloud-based actuator electronic controller 802 and a user device 804. The cloud-based actuator electronic controller 802 may include an application server 806, a database 808, and a data server 810. The user device 804 may include one or more devices associated with user profiles of the actuator electronic controller 800, such as a smartphone 812 and/or a personal computer 814. The actuator electronic controller 800 may include external resources such as an external application server 816 and/or an external database 818. The various elements of the actuator electronic controller 800 may communicate via various communication links 820. An external resource may generally be considered a data resource owned and/or operated by an entity other than an entity that utilizes the cloud-based actuator electronic controller 802 and/or the user device 804.

The actuator electronic controller 800 may be web-based. The user device 804 may access the cloud-based actuator electronic controller 802 via an online portal set up and/or managed by the application server 806. The actuator electronic controller 800 may be implemented using a public internet. The actuator electronic controller 800 may be implemented using a private intranet. Elements of the project management system 100, such as the database 808 and/or the data server 810, may be physically housed at a location remote from an entity that owns and/or operates the actuator electronic controller 800. For example, various elements of the actuator electronic controller 800 may be physically housed at a public service provider such as a web services provider. Elements of the actuator electronic controller 800 may be physically housed at a private location, such as at a location occupied by the entity that owns and/or operates the actuator electronic controller 800.

The communication links 820 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an Ethernet cable connection, a fiber-optic connection, a FireWire connection, a microwire connection, and so forth. In another example, the direct link may include a cable on a bus network. “Direct,” when used regarding the communication links 820, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links 820, may refer to any of the aforementioned indirect communication links.

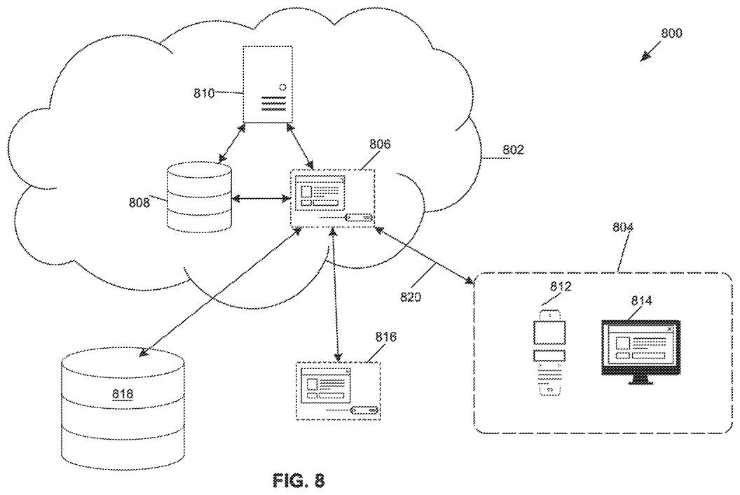

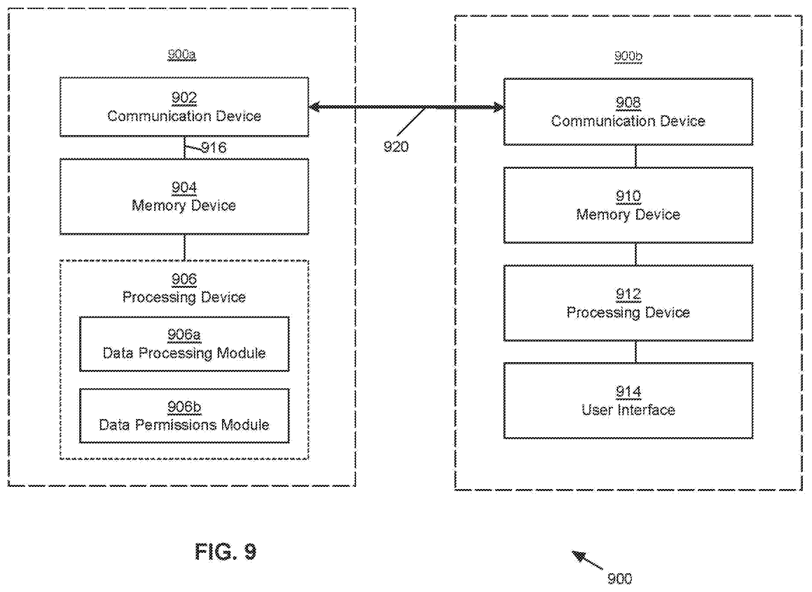

FIG. 9 illustrates a device schematic 900 for various devices used in the actuator electronic controller 800, according to an embodiment. A server device 900a may moderate data communicated to a client device 900b based on data permissions to minimize memory resource allocation at the client device 900b.

The server device 900a may include a communication device 902, a memory device 904, and a processing device 906. The processing device 906 may include a data processing module 906a and a data permissions module 906b, where the module refers to specific programming that governs how data is handled by the processing device 906. The client device 900b may include a communication device 908, a memory device 910, a processing device 912, and a user interface 914. Various hardware elements within the server device 900a and/or the client device 900b may be interconnected via a system bus 916. The system bus 916 may be and/or include a control bus, a data bus, and address bus, and so forth. The communication device 902 of the server device 900a may communicate with the communication device 908 of the client device 900b.

The data processing module 906a may handle inputs from the client device 900a. The data processing module 906a may cause data to be written and stored in the memory device 904 based on the inputs from the client device 900b. The data processing module 906a may retrieve data stored in the memory device 904 and output the data to the client device 900a via the communication device 902. The data permissions module 906b may determine, based on permissions data stored in the memory device, what data to output to the client device 900b and what format to output the data in (e.g. as a static variable, as a dynamic variable, and so forth). For example, a variable that is disabled for a particular user profile may be output as static. When the variable is enabled for the particular user profile, the variable may be output as dynamic.

The server device 900a may be representative of the cloud-based actuator electronic controller 802. The server device 800a may be representative of the application server 806. The server device 900a may be representative of the data server 810. The server device 900a may be representative of the external application server 816. The memory device 904 may be representative of the database 808 and the processing device 906 may be representative of the data server 810. The memory device 904 may be representative of the external database 818 and the processing device 906 may be representative of the external application server 816. For example, the database 808 and/or the external database 818 may be implemented as a block of memory in the memory device 904. The memory device 904 may further store instructions that, when executed by the processing device 906, perform various functions with the data stored in the database 808 and/or the external database 818.

Similarly, the client device 900b may be representative of the user device 804. The client device 900b may be representative of the smartphone 812. The client device 900b may be representative of the personal computer 814. The memory device 910 may store application instructions that, when executed by the processing device 912, cause the client device 900b to perform various functions associated with the instructions, such as retrieving data, processing data, receiving input, processing input, transmitting data, and so forth.

As stated above, the server device 900a and the client device 900b may be representative of various devices of the actuator electronic controller 800. Various of the elements of the actuator electronic controller 800 may include data storage and/or processing capabilities. Such capabilities may be rendered by various electronics for processing and/or storing electronic signals. One or more of the devices in the actuator electronic controller 800 may include a processing device. For example, the cloud-based data management system 802, the user device 804, the smartphone 812, the personal computer 814, the external application server 816, and/or the external database 818 may include a processing device. One or more of the devices in the actuator electronic controller 800 may include a memory device. For example, the cloud-based data management system 802, the user device 804, the smartphone 812, the personal computer 814, the external application server 816, and/or the external database 818 may include the memory device.

The processing device may have volatile and/or persistent memory. The memory device may have volatile and/or persistent memory. The processing device may have volatile memory and the memory device may have persistent memory. Memory in the processing device may be allocated dynamically according to variables, variable states, static objects, and permissions associated with objects and variables in the project management system 100. Such memory allocation may be based on instructions stored in the memory device. Memory resources at a specific device may be conserved relative to other systems that do not associate variables and other object with permission data for the specific device.

The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned specific devices, elements, and/or features of the processing device.

The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned specific devices, elements, and/or features of the memory device.

Various of the devices in the project management system 100 may include data communication capabilities. Such capabilities may be rendered by various electronics for transmitting and/or receiving electronic and/or electromagnetic signals. One or more of the devices in the project management system 100 may include a communication device, e.g., the communication device 202 and/or the communication device 208. For example, the cloud-based data management system 102, the user device 104, the smartphone 112, the personal computer 114, the application server 116, and/or the external database 118 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the project management system 100 may be referred to as a “server.” Such elements may include a server device. The server device may include a physical server and/or a virtual server. For example, the server device may include one or more bare-metal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to the functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the project management system 100, including the server device 200a and/or the client device 200b, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

Various methods are described below. The methods may be implemented by the data analysis system 100 and/or various elements of the data analysis system described above. For example, inputs indicated as being received in a method may be input at the client device 200b and/or received at the server device 200a. Determinations made in the methods may be outputs generated by the processing device 206 based on inputs stored in the memory device 204. Correlations performed in the methods may be executed by the correlation module 206a. Inference outputs may be generated by the inference module 206b. Key data and/or actionable data may be stored in the knowledge database 204b. Correlations between key data and actionable data may be stored in the knowledge database 204b. Outputs generated in the methods may be output to the output database 204c and/or the client device 200b. In general, data described in the methods may be stored and/or processed by various elements of the data analysis system 100

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods, and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

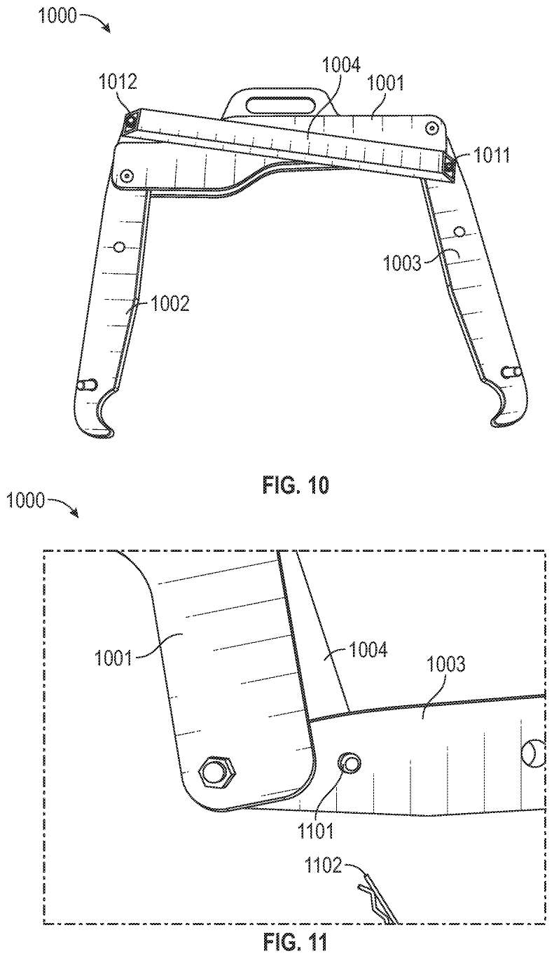

FIG. 10 illustrates a system level of a chain puller in an open configuration, according to an alternate embodiment. In the alternate embodiment of the chain puller, the chain puller 1000 is shown in an open configuration with the actuator subsystem removed. The chain puller 1000 comprises a top support member 1001, a first arm member 1002 coupled to a first side of the top support member 1001, a second arm member 1003 coupled to a second side of the top support member 1001, and a cross support member 1004 coupled at a first end 1012 to the top support member 1001 and at a second end 1011 to the second arm member 1004. In the open configuration, the first arm member 1002 and the second arm member 1003 extend downward from the top support member 1001.

FIG. 11 illustrates a linkage disconnect of a chain puller, according to the alternate embodiment. The coupling of the second arm member 1003 and the cross support member 1004 utilizes a connection pin 1101 passing through both the second arm member 1003 and the cross support member 1004. The connection pin 1001 is secured in place using a cotter pin 1102. When the cotter pin 1102 is removed from the connection pin 1101, the connection pin 1101 may be removed to decouple the second arm member 1003 and the cross support member 1004.

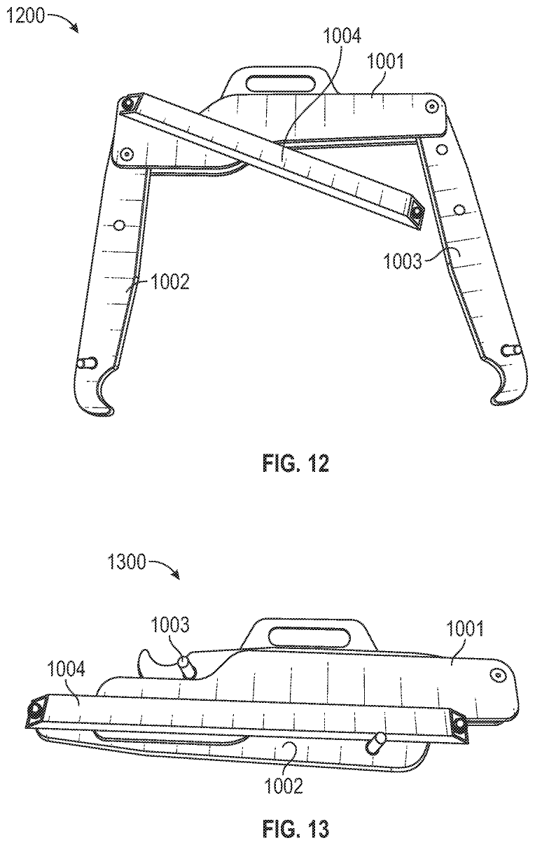

FIG. 12 illustrates a system level of a chain puller in a disconnected configuration, according to the alternate embodiment. Once the cotter pin 1102 and connection pin 1101 are moved, the cross support member 1004 may pivot downward away from the second arm member 1003. The first arm member 1002 and the second arm member 2003 may pivot into the collapsed configuration.

FIG. 13 illustrates a system level of a chain puller in a collapsed configuration, according to the alternate embodiment. In the collapsed configuration of the chain puller 1300, the first arm member 1002 pivots upward to contact the cross support member 1004 until the cross support member 1004 is adjacent to a bottom surface of the top support member 1001. The second arm member 1003 pivots upward until the second arm member 1003 is adjacent to a top surface of the top support member 1001. The second arm member 1003 may be positioned within a storage slot within the top support member 1001.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions, and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively inclusive elements does not preclude other examples that include various combinations of some or all of the alternatively inclusive elements. An example described using a list of alternatively-inclusive elements includes at least one element of the listed elements. However, an example described using a list of alternatively-inclusive elements does not preclude another example that includes all of the listed elements. And an example described using a list of alternatively inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements, and/or properties may be claimed through amendment of those claims or presentation of new claims in the present application or in a related application. Such amended or new claims, whether they are directed to the same example or a different example and whether they are different, broader, narrower, or equal in scope to the original claims, are to be considered within the subject matter of the examples described herein.

1. A chain puller apparatus, comprising:
a linkage subsystem having a first engagement end and a second engagement end, the linkage subsystem comprises:
a first arm including a first linkage end and a first engagement end;
a second arm including a second linkage end and a second engagement end;
a first linkage including a first proximal end connected to the first arm and a first distal end connected to the second arm; and
a second linkage including a second proximal end connected to the first arm and a second distal end connected to the second arm;
an actuation subsystem, the actuator subsystem comprises:
an actuator having a first end connected to the first arm and a second end connected to the second arm, the actuator comprises a hydraulic piston actuator, a pneumatic piston actuator, and a linear electric actuator;
a connection line coupled to the actuator, the connection line comprises a hydraulic hose, a pneumatic hose; and one or more wires; and
an external driver coupled to the connection line, the external driver is a hydraulic pump, a pneumatic pump, and an electronic controller;
wherein the linkage subsystem and the actuator subsystem are configured such that when the actuator subsystem is actuated, a distance between the first engagement end and the second engagement end is changed;
wherein the first arm, the second arm, the first linkage, the second linkage, and the actuator subsystem are configured such that when the actuator subsystem is actuated, a distance between the first engagement end and the second engagement end is changed; and
wherein the electronic controller comprises a machine interface, a machine control unit, a control panel, and a switch

2. A chain puller apparatus, comprising:
a linkage subsystem having a first engagement end and a second engagement end; and
an actuation subsystem;
wherein the linkage subsystem and the actuator subsystem are configured such that when the actuator subsystem is actuated, a distance between the first engagement end and the second engagement end is changed.

3. The chain puller apparatus according to claim 2, wherein the linkage subsystem comprises:
a first arm including a first linkage end and a first engagement end;
a second arm including a second linkage end and a second engagement end;
a first linkage including a first proximal end connected to the first arm and a first distal end connected to the second arm; and
a second linkage including a second proximal end connected to the first arm and a second distal end connected to the second arm;
wherein the first arm, the second arm, the first linkage, the second linkage, and the actuator subsystem are configured such that when the actuator subsystem is actuated, a distance between the first engagement end and the second engagement end is changed.

4. The chain puller apparatus according to claim 3, wherein the first engagement end and the second engagement end are configured with hook cutouts configured to partially encircle shear pins of a conveyor chain, therefore reducing a susceptibility of the respective engagement end to slip off the conveyor chain when compressing a section of the conveyor chain to be slacked.

5. The chain puller apparatus according to claim 3, wherein the first engagement end and the second engagement end are configured with pins or protrusions, larger than a width of a conveyor chain the chain puller apparatus is rated to be used for.

6. The chain puller apparatus according to claim 3, wherein the first linkage and the second linkage 106 are arranged in a crossover fashion, such that the first proximal end of the first linkage connected to the first arm is closer to the first linkage end than the second proximal end of the second linkage connected to the first arm, and the second proximal end of the second linkage connected to the second arm is closer to the second linkage end than the first proximal end of the first linkage connected to the second arm.

4. The chain puller apparatus according to claim 2, wherein the actuator subsystem comprises:
an actuator having a first end connected to the first arm and a second end connected to the second arm;
a connection line coupled to the actuator; and
an external driver coupled to the connection line.

5. The chain puller apparatus according to claim 4, wherein the actuator is a hydraulic piston actuator;
the connection line is a hydraulic hose; and
the external driver is a hydraulic pump.

6. The chain puller apparatus according to claim 4, wherein the actuator is a pneumatic piston actuator;
the connection line is a pneumatic hose; and
the external driver is a pneumatic pump.

7. The chain puller apparatus according to claim 4, wherein the actuator comprises a linear electric actuator;
the connection line comprises one or more wires; and
the external driver is an electronic controller.

8. The chain puller apparatus according to claim 7, wherein the electronic controller comprises a machine interface, a machine control unit, a control panel, and a switch.

9. The chain puller apparatus according to claim 2, wherein
the linkage subsystem comprises:
a first arm including a first linkage end and a first engagement end;
a second arm including a second linkage end and a second engagement end;
a first linkage including a first proximal end connected to the first arm and a first distal end connected to the second arm; and
a second linkage including a second proximal end connected to the first arm and a second distal end connected to the second arm;
wherein the first arm, the second arm, the first linkage, the second linkage, and the actuator subsystem are configured such that when the actuator subsystem is actuated, a distance between the first engagement end and the second engagement end is changed; the actuator subsystem comprises:
an actuator having a first end connected to the first arm and a second end connected to the second arm, the actuator comprises a hydraulic piston actuator, a pneumatic piston actuator, and a linear electric actuator;
a connection line coupled to the actuator, the connection line comprises a hydraulic hose, a pneumatic hose; and one or more wires; and
an external driver coupled to the connection line, the external driver is a hydraulic pump, a pneumatic pump, and an electronic controller;
wherein the electronic controller comprises a machine interface, a machine control unit, a control panel, and a switch.

10. A method, comprising:
providing a chain puller device, the chain puller device comprises:
a linkage subsystem having a first engagement end and a second engagement end; and
an actuation subsystem;
running a conveyor to a desired position, the conveyor comprising a conveyor chain, the conveyor chain having a normal tension and a relaxed tension;
engaging the chain puller to the conveyor chain; and
activating the actuation subsystem until the conveyor chain possesses the relaxed tension;
wherein the linkage subsystem and the actuator subsystem are configured such that when the actuator subsystem is actuated, a distance between the first engagement end and the second engagement end is changed.

11. The method according to claim 10, wherein the linkage subsystem comprises:
a first arm including a first linkage end and a first engagement end;
a second arm including a second linkage end and a second engagement end;
a first linkage including a first proximal end connected to the first arm and a first distal end connected to the second arm; and
a second linkage including a second proximal end connected to the first arm and a second distal end connected to the second arm;
wherein the first arm, the second arm, the first linkage, the second linkage, and the actuator subsystem are configured such that when the actuator subsystem is actuated, a distance between the first engagement end and the second engagement end is changed.

12. The method according to claim 11, wherein the first engagement end and the second engagement end are configured with hook cutouts configured to partially encircle shear pins of a conveyor chain, therefore reducing a susceptibility of the respective engagement end to slip off the conveyor chain when compressing a section of the conveyor chain to be slacked.

13. The method according to claim 12, wherein the first engagement end and the second engagement end are configured with pins or protrusions, larger than a width of a conveyor chain the chain puller apparatus is rated to be used for.

14. The method according to claim 13, wherein the first linkage and the second linkage 106 are arranged in a crossover fashion, such that the first proximal end of the first linkage connected to the first arm is closer to the first linkage end than the second proximal end of the second linkage connected to the first arm, and the second proximal end of the second linkage connected to the second arm is closer to the second linkage end than the first proximal end of the first linkage connected to the second arm.

15. The method according to claim 14, wherein the actuator subsystem comprises:
an actuator having a first end connected to the first arm and a second end connected to the second arm;
a connection line coupled to the actuator; and
an external driver coupled to the connection line.

16. The method according to claim 15, wherein the actuator is a hydraulic piston actuator;
the connection line is a hydraulic hose; and
the external driver is a hydraulic pump.

17. The method according to claim 16, wherein the actuator is a pneumatic piston actuator;
the connection line is a pneumatic hose; and
the external driver is a pneumatic pump.

18. The method according to claim 17, wherein the actuator comprises a linear electric actuator;
the connection line comprises one or more wires; and
the external driver is an electronic controller.

19. The method according to claim 18, wherein the electronic controller comprises a machine interface, a machine control unit, a control panel, and a switch.

20. The method according to claim 10, wherein the method further comprises:
activating the actuation subsystem to restore the conveyor chain to the normal tension; and
disengaging the chain puller from the conveyor chain.
